(19) United States
(12) Patent Application Publication
(10) Pub. No.: US 2019/0106144 A1
(43) Pub. Date: Apr. 11, 2019

(54) Garbage Bin Carting System

(71) Applicant: Pam McCall, Placida, FL (US)

(72) Inventor: Pam McCall, Placida, FL (US)

(21) Appl. No.: 15/729,282

(22) Filed: Oct. 10, 2017

(51) Int. Cl. B62D 1/28; B65F 1/14

(52) U.S. Cl. CPC B62D 1/283; B65F 2210/165; B65F 1/1468

(57) ABSTRACT

A garbage bin carting system for securing and transporting a garbage bin includes a cart that moves over a ground surface. The cart is motorized and remotely controlled. A saddle is mounted on top of the cart. The saddle releasably secures a garbage bin to the cart such that the garbage bin is transportable by the cart.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to remote controlled cart devices and more particularly pertains to a new remote controlled cart device for securing and transporting a garbage bin.

### BRIEF SUMMARY OF THE INVENTION

An embodiment of the disclosure meets the needs presented above by generally comprising a cart configured to move over a ground surface. The cart is motorized and remotely controlled. A saddle is mounted on top of the cart. The saddle is configured to releasably secure a garbage bin to the cart such that the garbage bin is transportable by the cart.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a garbage bin carting system according to an embodiment of the disclosure.

FIG. 2 is a back view of an embodiment of the disclosure.

FIG. 3 is a cross-sectional view of an embodiment of the disclosure taken along line 3-3 of FIG. 1.

FIG. 4 is a top view of an embodiment of the disclosure.

FIG. 5 is a top perspective view of an embodiment of the disclosure.

### DETAILED DESCRIPTION OF THE INVENTION

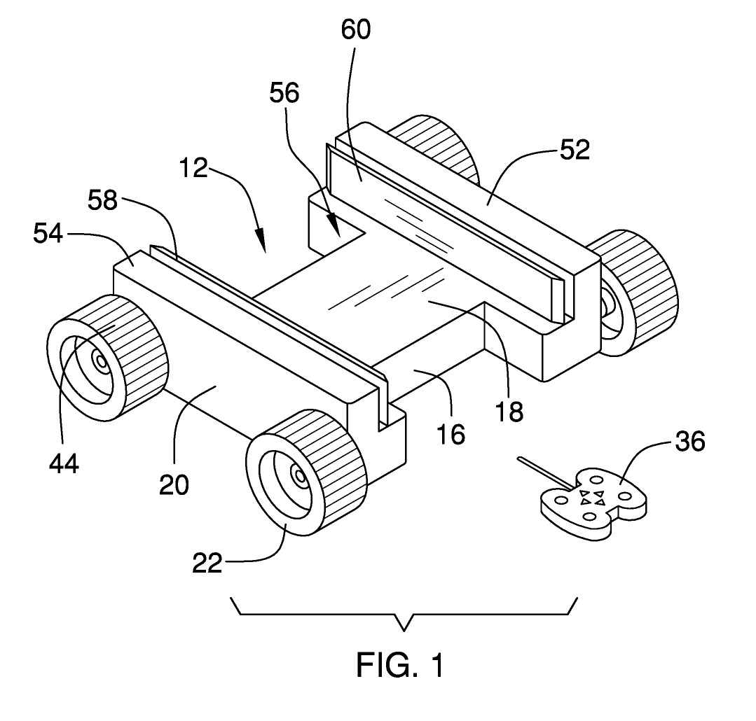

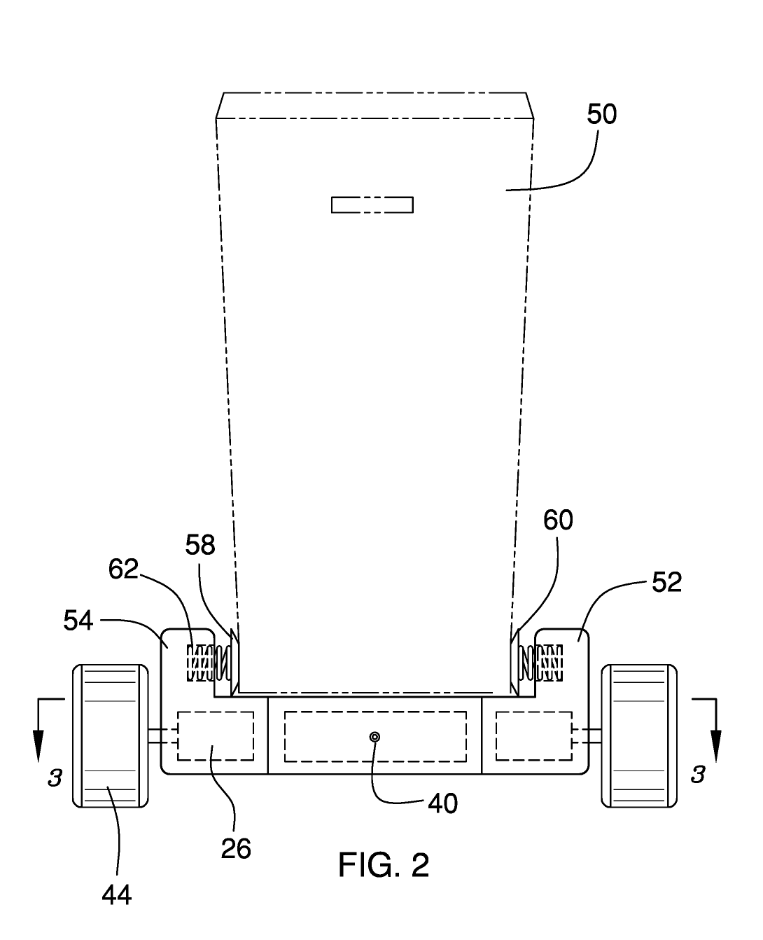

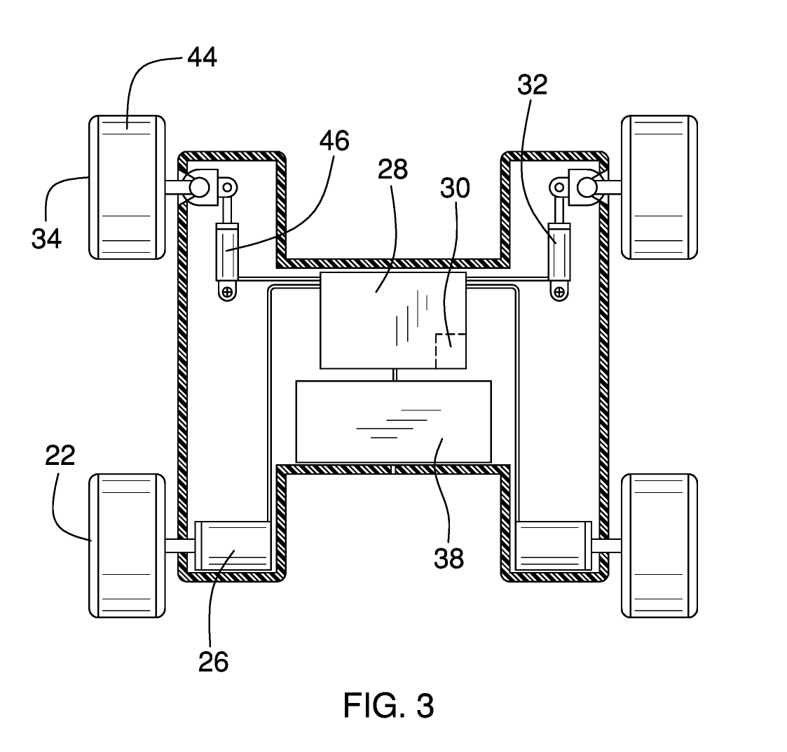

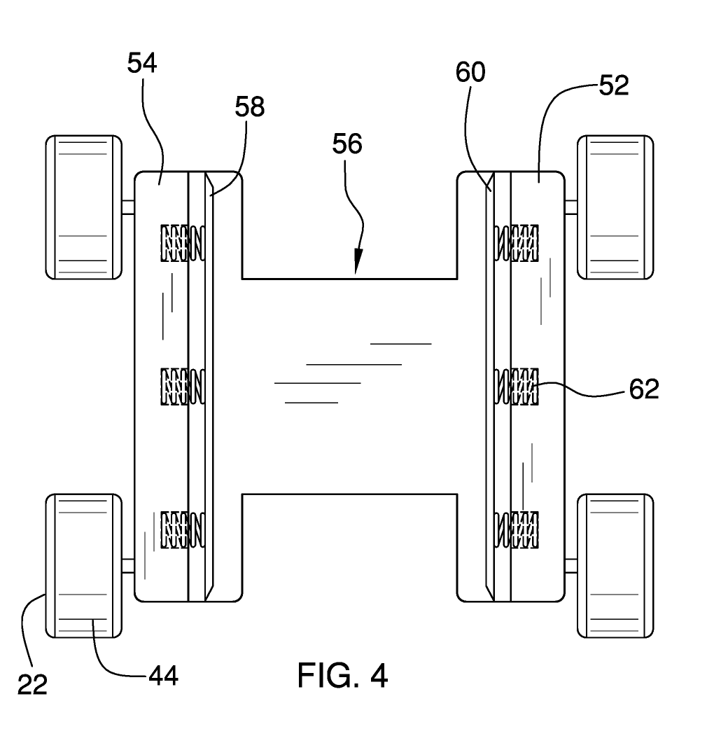

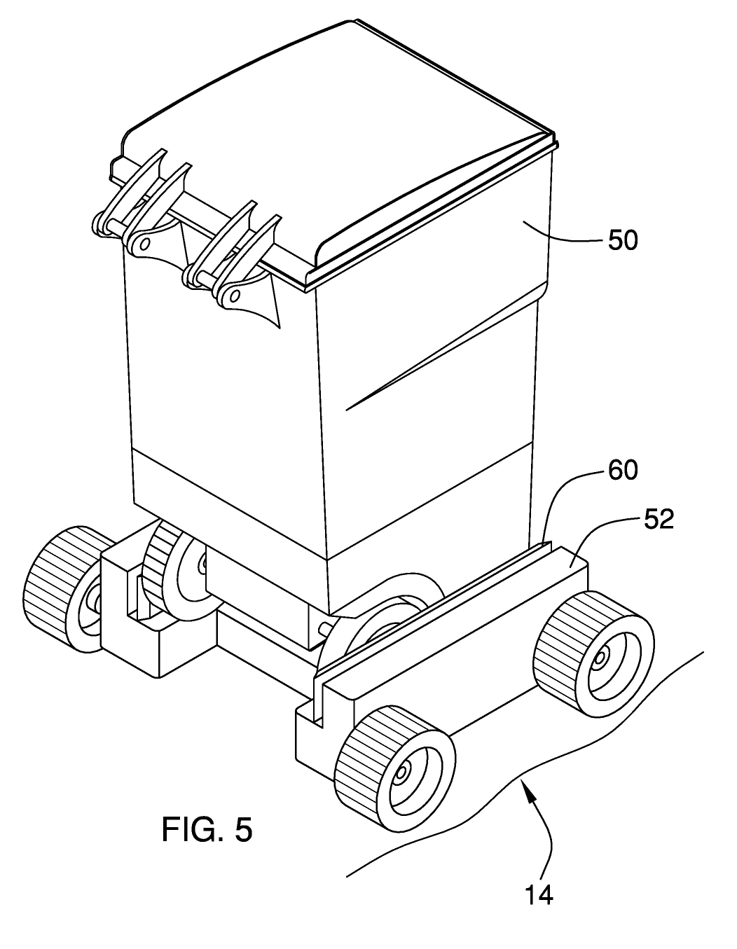

With reference now to the drawings, and in particular to FIGS. 1 through 5 thereof, a new remote controlled cart device embodying the principles and concepts of an embodiment of the disclosure and generally designated by the reference numeral 10 will be described.

As best illustrated in FIGS. 1 through 5, the garbage bin carting system 10 generally comprises a cart 12 that moves over a ground surface 14. The cart 12 is motorized and remotely controlled. The cart 12 includes a body 16 has a top wall 18 and a perimeter wall 20 is attached to and extends downwardly therefrom. A plurality of wheels 22 is rotatably mounted to the body 12 and extends downwardly therefrom such that the body 12 is supported by the plurality of wheels 22. A drive system 24 is mechanically coupled to the wheels 22. The drive system 24 includes a motor 26 that is mechanically coupled to at least one of the wheels 22. A control circuit 28 is electrically coupled the motor 26. A receiver 30 is electrically coupled to the control circuit 28. The receiver 30 receives control signals. A steering actuator 32 is electrically coupled to the control circuit 28. The steering actuator 32 is mechanically coupled to at least two of the wheels 22 and defines steerable wheels 34. The steering actuator 32 is actuated to selectively direct a rotational axis of the steerable wheels 34. The steerable wheels 34 have a rotational axis that remains orientated parallel to each other. A remote control 42 is in wireless communication with the receiver 30. The remote control 36 is actuated to operate the motor 26 and the steering actuator 32. A power supply 38 is electrically coupled to the control circuit 28. The power supply 38 may comprise a rechargeable battery and a charging port 40 is electrically coupled to the power supply 38.

Alternatively, the cart 12 may include a bottom wall 42. The drive system 24 may comprise of two motors 26. Each of the motors 26 is mechanically coupled to at least one of the wheels 22. The wheels 22 may have treads 44 attached thereto such that the wheels 22 frictionally engage the ground surface 14. The treads 44 may comprise of a polyurethane material but may be any material that allows the wheels 22 to frictionally engage the ground surface 14. The steering actuator 32 may comprise of a pair of linear actuators 40. Each of the linear actuators 46 attaches to one of at least two wheels 22 such that each wheel 22 is attached to an associated on of the linear actuators 46.

Alternatively, the steerable wheels 34 may be mechanically coupled to a single track rod that rotates both steerable wheels 34 in the same direction. Generally, it should be understood that the cart 12 comprises a conventional remote controlled vehicle and therefore numerous ways of controlling and providing locomotion for such are well established in the prior art of remote controlled vehicles.

A saddle 48 is mounted on top wall 18 of the cart 12. The saddle 48 is releasably secures a garbage bin 50 to the cart 12 such that the garbage bin 50 is transportable by the cart 12. The saddle 48 frictionally engages the garbage bin 50. The saddle 48 comprises a pair of walls 52, 54. Each of the walls 52, 54 is attached to and extends upwardly from the top wall 18 of the cart. Each of the walls 52, 54 is spaced from each other to define a receiving space 56 therebetween to define a receiving space 56 for the garbage bin 50. Each of the walls 52, 54 is elongated orientated parallel to each other. A pair of panels 58, 60, each of the walls 52, 54 has one of the panels 58, 60 mounted thereto such that the panels 58, 60 face each other and are positioned within the receiving space 56. A plurality of springs 62 is provided and each of the panels 58, 60 is attached to an associated one of the walls 52, 54 by at least one of the springs 62 such that the panels 58, 60 are biased toward each other.

Alternatively, the cart 12 may have an onboard mounted computer that is programmable to move the cart 12 with the garbage bin 50 engaged thereon at selected intervals. The computer may receive controls through the remote control 36 such that a user may use the remote control 36 to alter the selected time for the computer to move the garbage bin 50.

In use, the assembly 10 is used to secure and haul the garbage bin 50. The garbage bin 50 is releasably secured to the receiving space 56 of the cart 12. Once secured the cart 12 can be remote controlled to transport the garbage bin 50 wherever it is needed such as to the curb for trash pickup.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remote controlled cart assembly configured for securing and transporting a garbage bin, said assembly comprising:
a cart configured for moving over a ground surface, said cart being motorized and remotely controlled; and
a saddle being mounted on top of said cart, said saddle being configured to releasably secure a garbage bin to said cart such that the garbage bin is transportable by said cart.

2. The remote controlled cart assembly according to claim 1, wherein said cart includes:
a body having a top wall and a perimeter wall being attached to and extending downwardly therefrom;
a plurality of wheels being rotatably mounted to said body and extending downwardly therefrom such that said body is supported by said plurality of wheels;
a drive system being mechanically coupled to said wheels, said drive system including:
a motor being mechanically coupled to at least one of said wheels;
a control circuit being electrically coupled said motor;
a receiver being electrically coupled to said control circuit, said receiver being configured to receive control signals;
a steering actuator being electrically coupled to said control circuit, said steering actuator being mechanically coupled to at least two of said wheels defining steerable wheels, said steering actuator being actuated to selectively direct a rotational axis of said steerable wheels, said steerable wheels having rotational axes remaining orientated parallel to each other;
a remote control being in wireless communication with said receiver, said remote control being actuated to operate said motor and said steering actuator; and
a power supply being electrically coupled to said control circuit.

3. The remote controlled cart assembly according to claim 1, wherein said saddle is configured to frictionally engage the garbage bin.

4. The remote controlled cart assembly according to claim 1, wherein said saddle comprises:
a pair of walls each being attached to and upwardly extending from said top wall of said cart, said walls being spaced from each other to define a receiving space therebetween to define a receiving space for the garbage bin, said walls being elongated orientated parallel to each other;
a pair of panels, each of said walls having one of said panels mounted thereto such that said panels face each other and are positioned within said receiving space;
said panels being biased toward each other to frictionally engage the garbage bin.

5. The remote controlled cart assembly according to claim 4, further including a plurality of springs, each of said panels being attached to an associated one of said walls by at least one of said springs to bias said panels toward each other.

6. The remote controlled cart assembly according to claim 1, wherein said saddle comprises:
a pair of walls each being attached to and upwardly extending from said top wall of said cart, said walls being spaced from each other to define a receiving space therebetween to define a receiving space for the garbage bin, said walls being elongated orientated parallel to each other;
a panel being attached to one of said walls and being biased toward an other one of said walls, said panel being configured to frictionally engage the garbage bin.

7. The remote controlled cart assembly according to claim 6, further including a spring, said spring attaching said panel to said wall and biasing said panel away from said wall.

8. A remote controlled cart assembly configured for securing and transporting a garbage bin, said assembly comprising:
a cart configured for moving over a ground surface, said cart being motorized and remotely controlled, said cart including:
a body having a top wall and a perimeter wall being attached to and extending downwardly therefrom;
a plurality of wheels being rotatably mounted to said body and extending downwardly therefrom such that said body is supported by said plurality of wheels;
a drive system being mechanically coupled to said wheels, said drive system including:
a motor being mechanically coupled to at least one of said wheels;
a control circuit being electrically coupled said motor;
a receiver being electrically coupled to said control circuit, said receiver being configured to receive control signals;
a steering actuator being electrically coupled to said control circuit, said steering actuator being mechanically coupled to at least two of said wheels defining steerable wheels, said steering actuator being actuated to selectively direct a rotational axis of said steerable wheels, said steerable wheels having rotational axes remaining orientated parallel to each other;
a remote control being in wireless communication with said receiver, said remote control being actuated to operate said motor and said steering actuator;
a power supply being electrically coupled to said control circuit, said power supply comprising a rechargeable battery;
a charging port being electrically coupled to said power supply;
a saddle being mounted on top of said cart, said saddle being configured to releasably secure a garbage bin to said cart such that the garbage bin is transportable by said cart, said saddle being configured to frictionally engage the garbage bin, said saddle comprising:
a pair of walls each being attached to and upwardly extending from said top wall of said cart, said walls being spaced from each other to define a receiving space therebetween to define a receiving space for the garbage bin, said walls being elongated orientated parallel to each other;
a pair of panels, each of said walls having one of said panels mounted thereto such that said panels face each other and are positioned within said receiving space; and
a plurality of springs, each of said panels being attached to an associated one of said walls by at least one of said springs such that said panels are biased toward each other.

9. A garbage transporting system comprising:
a garbage bin;
a cart configured for moving over a ground surface, said cart being motorized and remotely controlled; and
a saddle being mounted on top of said cart, said saddle releasably securing a garbage bin to said cart such that the garbage bin is transportable by said cart.

10. The remote controlled cart assembly according to claim 9, wherein said cart includes:
a body having a top wall and a perimeter wall being attached to and extending downwardly therefrom;
a plurality of wheels being rotatably mounted to said body and extending downwardly therefrom such that said body is supported by said plurality of wheels;
a drive system being mechanically coupled to said wheels, said drive system including:
a motor being mechanically coupled to at least one of said wheels;
a control circuit being electrically coupled said motor;
a receiver being electrically coupled to said control circuit, said receiver being configured to receive control signals;
a steering actuator being electrically coupled to said control circuit, said steering actuator being mechanically coupled to at least two of said wheels defining steerable wheels, said steering actuator being actuated to selectively direct a rotational axis of said steerable wheels, said steerable wheels having rotational axes remaining orientated parallel to each other;
a remote control being in wireless communication with said receiver, said remote control being actuated to operate said motor and said steering actuator; and
a power supply being electrically coupled to said control circuit.

11. The remote controlled cart assembly according to claim 9, wherein said saddle frictionally engages said garbage bin.

12. The remote controlled cart assembly according to claim 9, wherein said saddle comprises:
a pair of walls each being attached to and upwardly extending from said top wall of said cart, said walls being spaced from each other to define a receiving space therebetween to define a receiving space for said garbage bin, said walls being elongated orientated parallel to each other;
a pair of panels, each of said walls having one of said panels mounted thereto such that said panels face each other and are positioned within said receiving space;
said panels being biased toward each other to frictionally engage said garbage bin.

13. The remote controlled cart assembly according to claim 12, further including a plurality of springs, each of said panels being attached to an associated one of said walls by at least one of said springs to bias said panels toward each other.

14. The remote controlled cart assembly according to claim 9, wherein said saddle comprises:
a pair of walls each being attached to and upwardly extending from said top wall of said cart, said walls being spaced from each other to define a receiving space therebetween to define a receiving space for said garbage bin, said walls being elongated orientated parallel to each other;
a panel being attached to one of said walls and being biased toward an other one of said walls, said panel frictionally engaging said garbage bin.

15. The remote controlled cart assembly according to claim 14, further including a spring, said spring attaching said panel to said wall and biasing said panel away from said wall.
